(19) United States
(12) Patent Application Publication
(10) Pub. No.: US 2006/0222150 A1
(43) Pub. Date: Oct. 5, 2006

(54) Emergency call notification and response

(75) Inventor: Robert Lowmaster, Bartlett, IL (US)

Correspondence Address: HANLEY, FLIGHT & ZIMMERMAN, LLC, 20 N. WACKER DRIVE, SUITE 4220, CHICAGO, IL, 60606, US

(73) Assignee: SBC KNOWLEDGE VENTURES, L.P, RENO, NV (US)

(21) Appl. No.: 11/095,761

(22) Filed: Mar. 31, 2005

(51) Int. Cl. H04M 11/04

(52) U.S. Cl. 379/37; 379/45

(57) ABSTRACT

A technique for enabling information associated with an emergency call originating in a private network to be routed to entities other than public service entities designated to handle the emergency call. The private network is monitored for emergency calls originating in the network. Information associated with the emergency calls is identified. The identified information is forwarded to an entity associated with the private network.

### FIELD OF THE INVENTION

This invention relates to communication networks and more particularly to a technique for handling emergency calls made in a communication network.

### BACKGROUND OF THE INVENTION

In the United States, the telephone number “911” has been designated for handling emergencies that threaten human life or property. Dialing this emergency number places the caller in contact with a public service entity designated to handle the emergency call, such as a public safety answering point (PSAP). In a typical arrangement, the PSAP gathers information about the emergency call from the caller, identifies an appropriate agency to handle the call and forwards the call to the identified agency.

Some areas of the United States utilize an enhanced version of the standard 911 emergency service. This enhanced version is often called “enhanced 911” or simply E911. The E911 service is designed to automatically provide certain information about an emergency call to e.g., a PSAP. This information typically includes a telephone number and a name of an individual or entity from where the call was made.

In a typical E911 arrangement, a caller contacts a PSAP by dialing 911. The call is intercepted by a telephone service provider which accesses various databases to locate information about the call, such as an automatic number identification (ANI) and an emergency location identification number (ELIN) associated with the telephone used by the caller. The information is then sent by the service provider to the PSAP. An operator at the PSAP may communicate with the caller to gather more information and use the information to route the call to an appropriate agency that is equipped to handle the emergency, such as an ambulance, fire and rescue, police, sheriff and highway patrol.

### SUMMARY OF THE INVENTION

One problem with the above-described arrangement is that information about the call is not made available to certain private entities which may have a need or desire to know about emergency calls originating within, e.g., their private networks. For example, a company may desire to have information associated with emergency calls placed in their private network routed to the company's security center so that the security center may act as a first response to the call. The above-described arrangement does not provide this capability. Consequently, the company may not be able to rapidly respond to an emergency situation that is reported by an emergency call that originated in the company's private network.

The present invention overcomes shortcomings associated with the prior art by incorporating a technique that enables information associated with an emergency call originating in a private network to be routed to entities associated with the private network. According to an aspect of the present invention, a communication network is monitored for emergency calls originating from a private network. Information associated with the emergency calls is identified. The identified information is then forwarded to an entity associated with the private network that is designated to be informed of emergency calls originating in the private network.

In the illustrated embodiment, calls made on a private Voice over Internet Protocol (VoIP) Network are monitored by a server. An emergency call is made in the VoIP network from a remote communication unit (RCU). An RCU identifier (ID) associated with the RCU is provided to the server. The server uses the RCU ID to identify information associated with the RCU in a database. This information may include e.g., a location of the RCU as well as an employee number of an employee associated with the RCU, the medical history of the employee, a calendar of events associated with the employee, a log of calls made by the employee and a location of emergency equipment in the vicinity of the RCU. The identified information is provided to a security center associated with the private network where it is displayed.

Advantageously, by providing information associated with emergency calls to private entities, the present invention enables these entities to be aware of emergency calls made within their private networks. This in turn, enables these entities to, e.g., take action to respond to the emergency calls.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high-level schematic block diagram of a communication network that may be used with the present invention.

FIG. 2 is a high-level partial schematic block diagram of a server that may be used with the present invention.

FIG. 3 is schematic block diagram of a remote communication unit (RCU) identifier (ID) data structure that may be used with the present invention.

FIG. 4 is a schematic block diagram of an employee ID data structure that may be used with the present invention.

FIG. 5 is a schematic block diagram of an employee call log data structure that may be used with the present invention.

FIG. 6 is a flow chart of a sequence of steps that may be used to process an emergency call in accordance with aspect of the present invention.

### DETAILED DESCRIPTION OF AN ILLUSTRATIVE EMBODIMENT OF THE INVENTION

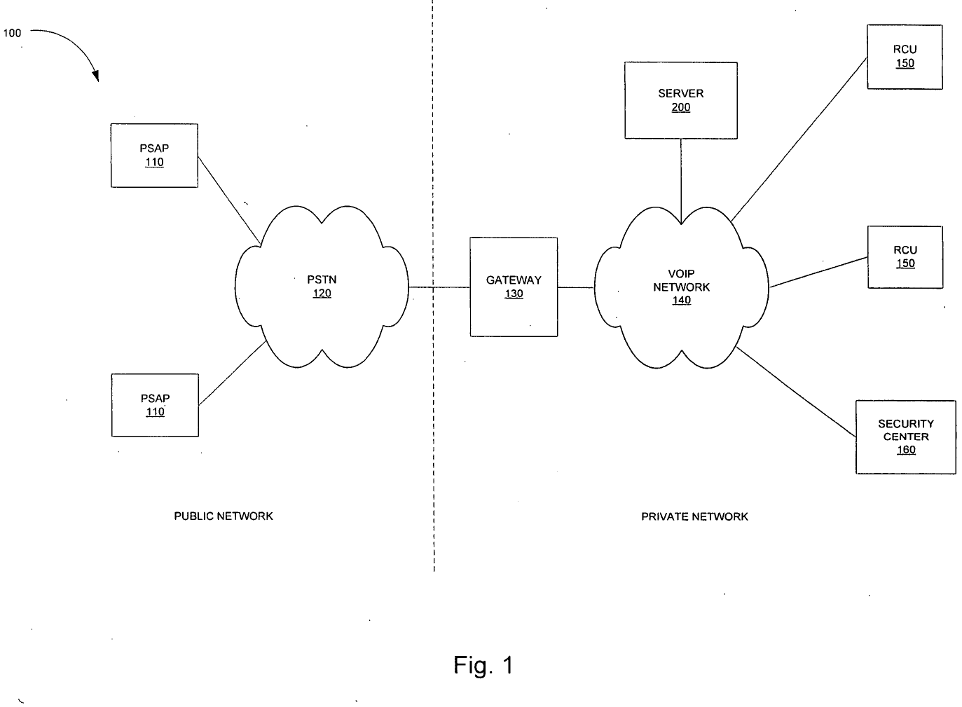

FIG. 1 is a high-level schematic block diagram of an exemplary communication network that may be used with the present invention. Network 100 comprises one or more public service answering points (PSAPs) 110, a public switched telephone network (PSTN) 120, a gateway node 130, a Voice over Internet Protocol (VoIP) network 140, one or more remote communication units (RCUs) 150, a security center 160 and a server 200. Illustratively, the PSAPs 110 and PSTN 120 comprise a public network portion of network 100 and the gateway node 130, VoIP network 140, RCUs 150, security center 160 and server 200 comprise a private network portion of the network 100.

A private network as used herein is a network operated for the benefit of a private entity. An example of a private network is a private telephone network operated for the benefit of a corporation. A public network as used herein is a network that is operated for the benefit of the general public.

It should be noted that functions of the private network may be provided internally by the private entity or externally by e.g., a service provider. For example, in network 100, a service provider may provide the functions performed by the gateway 150, VoIP network 140, RCUs 150, security center 160 and server 200, or some combination thereof.

The PSAPs 110 are conventional public safety answering point centers that are designated to handle emergency calls carried in the PSTN 120. This handling may include routing the emergency calls to an appropriate agency equipped to handle emergencies, such as an ambulance, a hospital, fire and rescue, police, sheriff and highway patrol. The PSTN 120 is a conventional public switched telephone network configured to, inter alia, handle emergency calls and route the emergency calls to the PSAPs 110. Gateway node 130 is illustratively a conventional data network gateway that interfaces the VoIP network 140 with the PSTN 120 and processes calls originating in the VoIP network 140 that are destined for the PSTN to the PSTN 120, and vice-versa. The VoIP network 140 is a conventional Voice over Internet Protocol network that is illustratively configured to implement a private telephone network. The VoIP network handles calls originating from the RCUs 150 as well as calls destined for the RCUs 150.

The RCUs 150 are remote telecommunication units, such as telephone hand sets, that enable telephone calls to be originated and received in VoIP network 140. Illustratively, each RCU 150 is associated with an identifier (ID) that uniquely identifies the RCU 150. When a telephone call is made at an RCU 150, the RCU's ID is illustratively included in signaling information associated with the telephone call.

Security center 160 is an entity that is associated with the VoIP network 140. The security center 160 may be a service provided by, e.g., a service provider to a business entity, such as a corporation. Alternatively, the security center may be an “in-house” security center provided by the e.g., business entity.

As will be described further below, the security center is illustratively configured to receive information about emergency calls made in the private network e.g., by the RCUs 150. Further, the security center 160 may be equipped to provide a first response to these emergency calls.

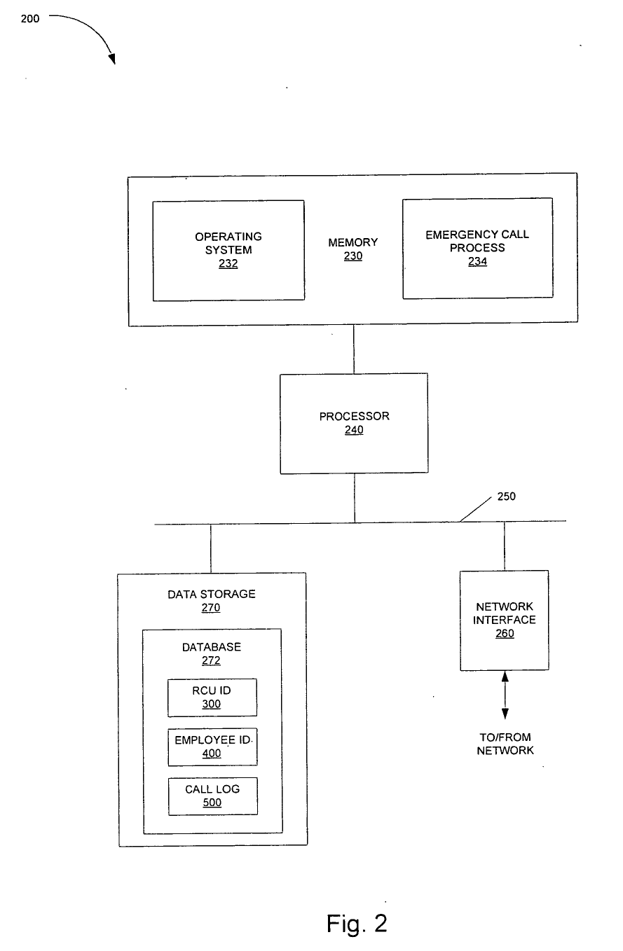

Server 200 is a conventional server configured to handle emergency calls originating in the VoIP network 140 in accordance with an aspect of the present invention. FIG. 2 is a high-level partial schematic block diagram of a server 200 that may be used with the present invention. Server 200 comprises a memory 230 coupled to a processor 240 which is also coupled to a network interface 260 and a data storage subsystem 270 via an input/output (I/O) bus 250. It should be noted that server 200 may further contain various I/O devices (not shown), such as display devices and keyboards.

The memory 230 is a computer readable medium organized as a random-access memory (RAM) that is illustratively implemented using RAM devices, such as dynamic-random-access memory (DRAM) devices. The memory 230 is configured to hold various computer executable instructions and data structures including computer executable instructions and data structures that implement aspects of the present invention. It should be noted that other computer readable mediums, such as disks and flash memory, may be configured to hold computer readable instructions and data that implement aspects of the present invention. In addition, it should be noted that various electromagnetic signals may be encoded to carry instructions and data that implement aspects of the present invention.

The memory 230 holds various software including an operating system 232 and an emergency call process 234. The operating system 232 may be a conventional multitasking operating system configured to implement various conventional operating system functions, such as task scheduling and memory management. The emergency call process 234 is a software process that is configured to implement aspects of the present invention.

The processor 240 is a conventional processor containing logic that is configured to execute various instructions and manipulate data structures contained in memory 230. Network interface 260 is a conventional network interface that comprises logic which e.g., interfaces the server 200 with network 100 and enables data to be transferred between the network 100 and the server 200. Data storage subsystem 270 is a conventional storage subsystem illustratively comprising one or more disk units that are configured to hold data for server 200. This data may include databases that are used to process emergency calls originating in the private network in accordance with an aspect of the present invention. Bus 250 is illustratively a conventional I/O bus that enables data (information) to be transferred between the processor 240 and I/O devices coupled to the bus 250, such as data storage 270 and network interface 260.

Database 272 is illustratively a conventional database accessible to the processor 240 that illustratively comprises one or more preconfigured data structures that hold information associated with emergency calls originating in the private network. This information may include an RCU ID associated with the RCU from where the call was placed as well as an employee ID of a person associated and a call log of calls made by the person. The preconfigured data structures are illustratively database tables which include an RCU ID table 300, an employee ID table 400 and a call log table 500.

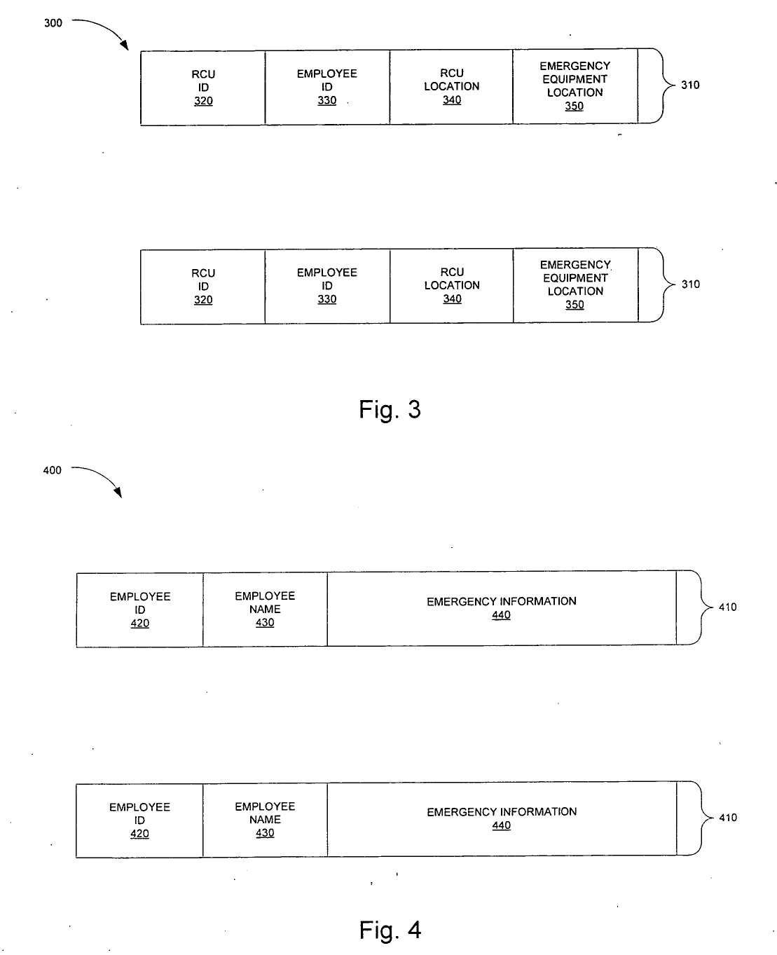

FIG. 3 is a schematic block diagram of an RCU ID table 300 that may be used with the present invention. Table 300 is a data structure illustratively organized as a database table comprising one or more entries 310 wherein each entry holds information associated with an RCU 150.

Entry 310 illustratively contains an RCU ID field 320, an RCU location field 330 and an emergency equipment location field 350. The RCU ID field 320 illustratively holds a value that represents an ID that is associated with an RCU 150. The RCU location field 330 illustratively holds a value that represents a location of the RCU 150. The emergency equipment location field 330 illustratively holds a value that represents a location associated with emergency equipment that may be located within e.g., a predefined vicinity of the RCU 150.

FIG. 4 is a schematic block diagram of an employee ID table 400 that may be used with the present invention. Table 400 is a data structure illustratively organized as a database table comprising one or more entries 410 wherein each entry 410 holds information about an employee associated with an RCU 150. Specifically, entry 410 illustratively contains an employee ID field 420, an employee name field 430 and an emergency information field 440. The employee ID field 420 illustratively holds a value that represents an ID of an employee associated with an RCU 150. The employee name field 430 illustratively holds a value that represents a name associated with the employee which may be a first name and a last name of the employee. The emergency information field 440 illustratively holds information that relates to the employee that may be relevant in an emergency situation. For example, this information may include a medical history of the employee, a contact name of a person to contact in the event of an emergency relating to the employee and a telephone number of the contact person.

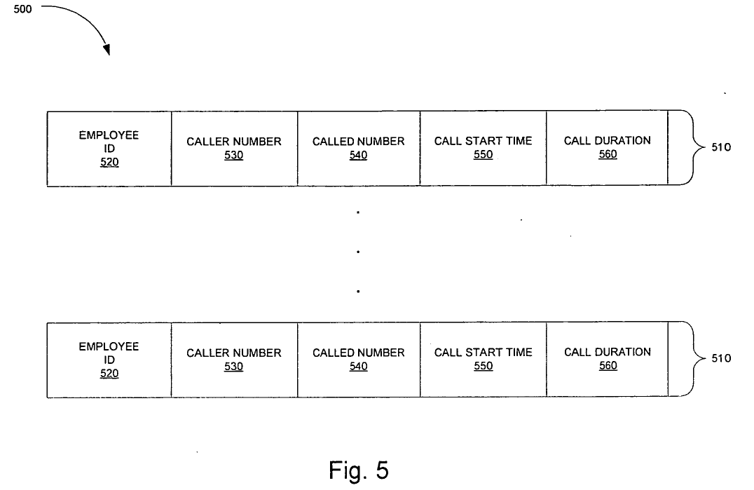

FIG. 5 is a schematic block diagram of a call log table 500 that may be used with the present invention. Table 500 is a data structure illustratively organized as a database table comprising one or more entries 510 wherein each entry 510 holds information related to a particular telephone call made or received by a particular employee. Entry 510 illustratively contains an employer ID field 520, a caller number field 530, a called number field 540, a call start time field 550 and a call duration field 560. The employee ID field 520 illustratively holds a value that represents an ID of the employee that made or received the telephone call. The caller number field 530 illustratively holds a value that represents a telephone number of the caller that made the call. The called number field 540 illustratively holds a value that represents a telephone number that was called. The call start time field 550 illustratively holds a value that represents a start time of the telephone call, and the call duration field 560 illustratively holds a value that represents a duration of the telephone call (e.g., in seconds).

It should be noted that database 272 may contain other data structures that hold information that may be relevant to an emergency situation. For example, database 272 may contain a data structure that holds information relating to phone calls received and/or originated by each RCU 150. Here, the information contained in the data structure may be similar to the information contained in the call log data structure wherein instead of maintaining an employee ID the data structure may maintain an RCU ID of the RCU 150 that received or originated the call instead.

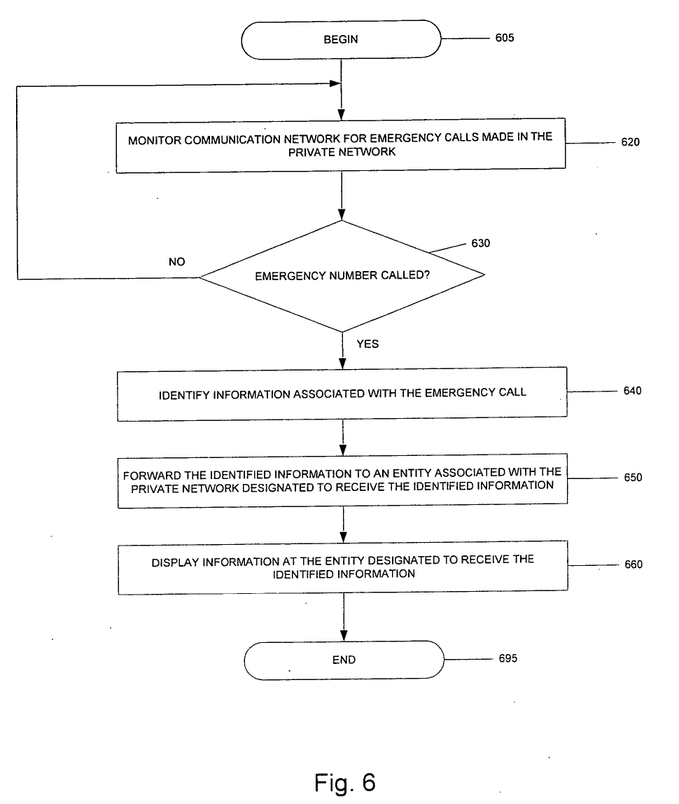

In accordance with an aspect of the present invention, server 200 monitors calls originated in the VoIP network 140 to determine if an emergency call is being made. If so, information associated with the emergency call is identified and forwarded to the security center 160 where the information is displayed. FIG. 6 is a flow chart of a sequence of steps that may be used to identify and process an emergency call in accordance with an aspect of the present invention.

The sequence begins at step 605 and proceeds to step 620 where calls made in the private network are monitored to determine if an emergency call is being made. Illustratively, server 200 determines if an emergency call is being made by monitoring signaling information carried in the VoIP network 140 associated with telephone calls made by the RCUs 150. The server 200 illustratively identifies a call as being an emergency call by examining the signaling information and concluding the call is an emergency call if e.g., the signaling information indicates that the caller dialed an emergency telephone number, such as 911. At step 630, if an emergency call is not being made (i.e., an emergency number has not been dialed), the sequence returns to step 620. Otherwise, if an emergency call is being made, the sequence proceeds to step 640 where information associated with the emergency call is identified. Illustratively, the server uses the RCU ID 320 provided by the RCU unit 150 making the emergency call to locate an entry 310 in the RCU ID table 300 whose RCU ID 320 matches the RCU ID 320 provided by the RCU unit 150. If a matching entry is found, the server utilizes the employee ID 330 contained in the matching entry 310 to locate an entry 410 in the employee ID database 400 that contains an employee ID 420 that matches the employee ID 330 of the matching RCU table entry 310.

In addition, the server 200 illustratively uses the employee ID 330 to locate call log entries 510 of calls made by the employee that may be relevant to the emergency call (e.g., calls made within a certain predetermined time frame prior to the emergency call). Illustratively, the server 200 compares the employee ID 330 of the matching entry 310 with the employee IDs 520 of entries 510 in the employee call log table 500 to locate entries 510 whose employee ID 520 matches the employee ID 310 of the matching RCU ID entry 310. The server 200 then illustratively examines the matching call log table entries 510 and filters-out those entries 510 that are not considered relevant to the emergency call (e.g., discards entries 510 whose call start time 550 falls outside the predetermined time frame).

At step 650, the server 200 forwards the identified information to an entity associated with the private network that is designated to receive the information. Illustratively, the server 200 forwards the employee ID 330, the RCU location 340 and the emergency equipment location 350 from the matching RCU ID entry 310, the employee name 430 and the emergency information 440 from the matching employee ID record 410 and, the caller number 530, the called number 540, the call start time 550 and the call duration 560 from relevant matching entries 510 in the call log database table 500 to the security center 160. At step 660, the forwarded information is displayed at the entity designated to receive the information (e.g., the security center 160).

For example, assume the private network in network 100 is utilized by a company and that an emergency call is placed from an RCU 150. At step 620, the server 200 monitors the VoIP network 140 and at step 630 determines that an emergency call has been placed that originated in the private network. At step 640, the server 200 accesses database 272 to identify information associated with the emergency call. Specifically, the server 200 uses an RCU ID supplied by the RCU 150 from where the call originated to locate an RCU ID table entry 310 whose RCU ID field 320 contains a value that matches the RCU ID of the RCU 150. The server 200 uses the employee ID 330 of the matching RCU ID table entry 310 to locate an employee ID table entry 410 whose employee ID field 420 contains a value that matches the employee ID 330 of the matching RCU ID table entry 310. The server 200 also uses the employee ID 330 to locate call log table entries 510 whose employee ID field 520 contains a value that matches the employee 330 of the matching RCU ID table entry 310. The server 200 may also apply a filter to the matching call log table entries 510 to filter-out those entries 510 that are not considered relevant to the emergency call (e.g., discards entries 510 whose call start time 550 falls outside a predetermined time frame). At step 650, the server 200 forwards the identified information to the security center 160 where it is displayed (step 660).

In an embodiment of the invention, the emergency call is recorded and stored illustratively by server 200 in e.g., a .wav file. This file is then forwarded to the entity associated with the private network that is designated to receive the information (e.g., the security center 160).

In yet another embodiment of the invention, the security center 160 displays a map indicating a location of the RCU 150 where the emergency call was made.

While this invention has been particularly shown and described with references to preferred embodiments thereof, it will be understood by those skilled in the art that various changes in form and details may be made therein without departing from the scope of the invention encompassed by the appended claims.

What is claimed is:

1. In a communication network having a public network portion and a private network portion, a method for handling emergency calls comprising the steps of:
monitoring the communication network for an emergency call originating from the private network;
identifying information associated with the emergency call; and
forwarding the identified information to an entity associated with the private network.

2. A method as defined in claim 1 further comprising the step of:
displaying the information at the entity associated with the private network.

3. A method as defined in claim 1 further comprising the steps of:
examining signaling information associated with calls made in the private network; and
concluding a call is an emergency call if the signaling information indicates that that an emergency telephone number was dialed.

4. A method as defined in claim 1 wherein the private network is a Voice Over Internet Protocol (VoIP) network.

5. A method as defined in claim 1 further comprising the steps of:
making a recording of the emergency call; and
forwarding the recording of the emergency call to the entity associated with the private network.

6. A method as defined in claim 1 wherein the entity associated with the private network is a security center.

7. A method as defined in claim 1 wherein the identified information includes an identifier (ID) associated with a remote communication unit (RCU) from where the emergency call was made.

8. A method as defined in claim 7 wherein the identified information includes a location of the RCU.

9. A method as defined in claim 7 wherein the information includes a location of emergency equipment in the vicinity of the RCU.

10. A method as defined in claim 7 wherein the information includes an identity of an individual associated with the RCU.

11. A method as defined in claim 10 wherein the information includes a medical history of the individual.

12. A method as defined in claim 10 wherein the information includes a calendar associated with the individual.

13. A method as defined in claim 10 wherein the information includes a log of calls made by the individual.

14. A server for handling emergency calls made in a communication network having a public portion and a private portion, the server comprising:
a processor; and
a memory coupled to the processor, the memory containing instructions executable by the processor for:
(a) monitoring the communication network for an emergency call originating from the private network,
(b) identifying information associated with the emergency call, and
(c) forwarding the identified information to an entity associated with the private network.

15. A server as defined in claim 14 wherein the memory contains instructions executable by the processor for:
(a) examining signaling information associated with calls made in the private network, and
(b) concluding a call is an emergency call if the signaling information indicates that that an emergency telephone number was dialed.

16. A server as defined in claim 14 wherein the memory contains instructions executable by the processor for:
(a) making a recording of the emergency call, and
(b) forwarding the recording of the emergency call to the entity associated with the private network.

17. A server as defined in claim 14 further comprising:
a database accessible to the processor, the database containing information associated with the emergency call.

18. A server as defined in claim 17 wherein the memory contains instructions executable by the processor for:
(a) acquiring a remote communication unit (RCU) identifier (ID) associated with an RCU that has originated an emergency call in the private network, and
(b) using the RCU ID to identify the information contained in the database that is associated with the call.

19. An apparatus for handling emergency calls made in a communication network having a public network portion and a private network portion, the apparatus comprising:
means for monitoring the communication network for an emergency call originating from the private network;
means for identifying information associated with the emergency call; and
means for forwarding the identified information to an entity associated with the private network.

20. A computer readable medium comprising computer executable instructions for:
monitoring a communication network, having a public network portion and a private network portion, for an emergency call originating from the private network;
identifying information associated with the emergency call; and
forwarding the identified information to an entity associated with the private network.

21. A computer readable medium as defined in claim 20, further comprising computer executable instructions for:
displaying the information at the entity associated with the private network.

22. A computer readable medium as defined in claim 20, further comprising computer executable instructions for:
examining signaling information associated with calls made in the private network; and
concluding a call is an emergency call if the signaling information indicates that that an emergency telephone number was dialed.

23. A computer readable medium as defined in claim 20, further comprising computer executable instructions for:
making a recording of the emergency call; and
forwarding the recording of the emergency call to the entity associated with the private network.

24. A computer readable medium as defined in claim 20 wherein the private network is a Voice Over Internet Protocol (VoIP) network.

25. A computer readable medium as defined in claim 20 wherein the entity associated with the private network is a security center.

26. A computer readable medium as defined in claim 20 wherein the identified information includes an identifier (ID) associated with a remote communication unit (RCU) from where the emergency call was made.

27. A computer readable medium as defined in claim 26 wherein the identified information includes a location of the RCU from where the emergency call was made.

28. A computer readable medium as defined in claim 26 wherein the information includes a location of emergency equipment in the vicinity of the RCU.

29. A computer readable medium as defined in claim 26 wherein the information includes an identity of an individual associated with the RCU.

30. A computer readable medium as defined in claim 29 wherein the information includes a medical history of the individual.

31. A computer readable medium as defined in claim 29 wherein the information includes a calendar associated with the individual.

32. A computer readable medium as defined in claim 29 wherein the information includes a log of calls made by the individual.

33. Electromagnetic signals propagating on a computer network, the electromagnetic signals carrying instructions for execution in a processor for:
monitoring a communication network, having a public network portion and a private network portion, for an emergency call originating from the private network;
identifying information associated with the emergency call; and
forwarding the identified information to an entity associated with the private network.
